(19) United States
(12) Patent Application Publication
(10) Pub. No.: US 2010/0066844 A1
(43) Pub. Date: Mar. 18, 2010

(54) APPARATUS AND METHOD FOR REMOTE INSPECTION OF A STRUCTURE USING A SPECIAL IMAGING SYSTEM

(75) Inventors: Alain Lortie, Terrebonne (CA); Sébastien Blier, Montreal (CA)

Correspondence Address: BENOIT & COTE, s.e.n.c., 1001, DE MAISONNEUVE BOULEVARD WEST, SUITE 210, MONTREAL, QC, H3A 3C8, CA

(73) Assignee: CT-ZOOM TECHNOLOGIES INC., Terrebonne (CA)

(21) Appl. No.: 12/533,385

(22) Filed: Jul. 31, 2009

Related U.S. Application Data
(62) Division of application No. 11/274,316, filed on Nov. 16, 2005.

(51) Int. Cl. H04N 5/232; G06F 17/30

(52) U.S. Cl. 348/211.6; 707/705; 348/E05.042; 707/E17.001

(57) ABSTRACT

The present invention relates to inspection of underground conduits, railroad bridge support structures and other facilities that may be examined remotely, using a video camera or other imaging system. The present invention provides fast and cost-effective systems and methods to inspect such structures remotely and to produce comprehensive and detailed information about inspected structures.

### CROSS REFERENCE TO RELATED PATENT APPLICATIONS

This non-provisional patent application is a divisional of co-pending U.S. patent application Ser. No. 11/274,316 filed on Nov. 16, 2005 and claims priority under 35 U.S.C. 120 therefrom.

### FIELD OF THE INVENTION

The present invention generally relates to the remote inspection of areas that are difficult to reach. More specifically, the invention relates to inspection of underground conduits, railroad bridge support structures and other facilities that may be examined remotely, using a video camera or other imaging system.

### BACKGROUND OF THE INVENTION

It is sometimes necessary to inspect certain areas that are inconvenient and/or time-consuming to access. For illustrative purposes, the inspection of underground conduits will be described, although the scope of the present invention is by no means limited to this application. Most municipalities contain a vast network of underground conduits. Periodically, these conduits must be inspected for problems such as cracks, blockage, build-up, and root infiltration. If a problem is detected, detailed images must be obtained to facilitate planning to remedy the situation.

Conventional sewer inspection methods are globally the same as they were decades ago. According to these conventional inspection methods, a target pipe must be cleaned before a camera is winched through to pinpoint problem areas. As a result, related inspection costs become tremendous due to costs of pumping and diverting water flow before the inspection (can double the costs of inspection of a small-diameter pipe and more than quintuple it in the case of larger sewer mains). Why would sewer pipes need to be cleaned for the sole purpose of being able to winch a camera through them? Experience has shown that, in over 70% of cases, pipes do not need to be cleaned. In fact, mainly because of budgetary reasons, traditional methods are limited to inspect relatively small sections of sewer systems. Moreover, by flushing pipes out before inspection, vital information that could actually help to pinpoint the problem could be destroyed. Such information comprises evidence of leakage, deposits, root infiltration and inadequate water level.

On another side, imaging systems used for inspection of underground conduits should be specially accommodated to operate efficiently in gloomy, humid and difficult to reach areas in order to be able to provide quality of imaging in a cost effective and a non time-consuming way. Traditional imaging systems for inspection of underground conduits lack efficiency because they are not suitably accommodated for such inconvenient areas.

### SUMMARY OF THE INVENTION

It is therefore an object of the present invention to provide apparatus and methods for remote inspection of a structure using a special imaging system that overcome the above drawbacks.

The present invention suggests fast and cost-effective systems and methods to produce comprehensive and detailed assessments of given sections of sewer systems. The present new technique produces impeccable detailed documentation to support budgetary requests and master plans. Therefore, it is possible to establish immediate inspection and cleaning priorities while obtaining a “big-picture” view of what needs to be done in the long term.

According to one aspect of the invention, there is provided an inspection system comprising:
a mast;
a support member to support the mast;
a camera with a first interface unit to control attributes of the camera, the camera being mounted on the mast;
a controllable high magnification ratio zoom with a zoom controller to control the high magnification ratio zoom, the zoom being mounted on the mast; electronically controllable light projectors with a second interface unit to control attributes of the light projectors, the light projectors being mounted on the mast; motors with a motor controller to mechanically control orientation of the camera, the zoom and the light projectors with respect to the mast; and a third interface unit located in proximity of the camera, the light projectors and the motors, the third interface unit having a single input signal and output signals connecting the third interface unit to each of the camera, the zoom controller, the light projectors and the motor controller.

According to another aspect of the invention, there is provided an inspection system comprising:
a mast;
a support member to support the mast;
a camera having an output video signal, the camera being mounted on the mast;
a server connected to the camera to store at least a part of the video signal outputted by the camera; and
a workstation connected to the server to control the video server to record the video signal and to transmit the recorded video signal to the workstation.

According to another aspect of the invention, there is provided a method of automatically generating attribute values defining controllable attribute values of an inspection imaging system for inspecting an object, the method comprising:
manually setting each of the to put the inspection imaging system in an initial state;
selecting a navigation template among stored navigation templates, where the navigation template contains at least one set of the attribute values defining controllable attribute values of the inspection imaging system;
executing the navigation template during inspection of the object to generate the at least one set of the attribute values, the attribute values including camera orientation, camera zoom and lighting intensity; and
sending the at least one set of the attribute values to the inspection imaging system to automatically navigate according to the selected navigation template.

According to another aspect of the invention, there is provided a system for automatically generating attribute values defining controllable attribute values of an inspection imaging system. The system comprises: a user interface unit for receiving commands from an end user to define the controllable attribute values; a motor control module connected to the user interface unit for acquiring a first user friendly data command and for outputting a first attribute signal to control position and orientation of the inspection imaging system; a zoom module connected to the user interface unit for acquiring a second user friendly data command and for outputting a second attribute signal to control a high magnification ratio zoom of a camera of the inspection imaging system; a camera module connected to the user interface unit for acquiring a third user friendly data command and for outputting a third attribute signal for controlling attributes of the camera; a light projector module connected to the user interface unit for acquiring a fourth user friendly data command and for outputting a fourth attribute signal for controlling attributes of electronically controllable light projectors of the inspection imaging system; a system interface unit for receiving the first, second, third and fourth attribute signals and for outputting corresponding imaging system control signals; a storage unit for storing navigation templates, where each of the navigation templates contains at least one set of the attribute values defining the controllable attribute values of the inspection imaging system; a select module connected to the storage unit for selecting a navigation template among the navigation templates in the storage unit; and an execute module connected to the select module for executing the selected navigation template and for outputting the selected navigation template to the inspection imaging system via the system interface unit.

According to a further aspect of the invention, there is provided a method of creating a text identification header using a database to automatically extract information in connection with an object. The method comprises: navigating an inspection imaging system mounted on a mast supported by a support member for inspection the object; recording the inspection to create an inspection video in connection with the object; selecting the object in a database containing information about the object; extracting, from the database, the information about the object; using the extracted information for automatically editing the text identification header in connection with the object; and merging the text identification header with the inspection video in connection with the object.

According to a further aspect of the invention, there is provided a system for creating an identification header using a database to automatically extract information in connection with an object, the system comprising: an inspection imaging system mounted on a mast supported by a support member to inspect the object; a storage unit for containing information about a given group of objects; a select module connected to the storage unit for selecting the object among the given group of objects in the storage unit; a header edit module connected to the select module for editing the identification header in connection with the object; and a video merge module connected to the header edit module for merging the edited identification header with an inspection video in connection with the object.

According to a further aspect of the invention, there is provided an inspection imaging system mounted on a mast supported by a support member, the imaging system comprising:
a camera with an electronically controllable high magnification ratio zoom to perform inspections both from close up and from a distance;
at least five light projectors to provide necessary lighting in the underground conduit; and
a housing containing the camera and the light projectors, the camera being centered in the housing and the light projectors surrounding the camera.

According to a further aspect of the invention, there is provided a method of inspecting an inspection object, the method comprising steps of:
determining appropriate optical composition of light to project as a function of an imaging environment;
selecting appropriate optical filters as a function of the appropriate optical composition of light to project;
placing the selected optical filters in front of light projectors of the inspection system, such that light projected by the light projectors on the inspection object is filtered by effect of the placed optical filters;
acquiring an image of the inspection object; and
analyzing the acquired image as a function of the optical composition of the projected light.

In the inspection system comprising light projectors, it is preferable that it comprises a power supply converter located in proximity of the light projectors, the power supply converter receiving a 48 volts current via a 48 volts cable connected to a remote power supply unit and converting the 48 volts to a 12 volts current in order to supply the light projectors.

In the inspection system comprising a camera with an output video signal connected to a server, the camera can be an analog camera having a controllable zoom, controllable orientation and controllable lighting for illuminating and imaging the conduit. In this case, the output video signal is an output analog video signal. The server can be part of a field relay unit providing power to the camera, the lighting and positioning motors, the field relay unit being connected to the camera to provide control signals and receive the output analog video signal from the camera and to the workstation via a data bus. It is preferable that the server comprises:
a CODEC device receiving the output analog video signal and converting the output analog video signal into a digital video signal and compressing the digital video signal for storage; and
a monitor image generator for sending a live monitor image from the camera to the workstation over the data bus.

The inspection systems of the present invention preferably comprise motors mounted on the mast to mechanically control orientation of the camera with respect to the mast.

In the method of automatically generating attribute values, it is preferable that the at least one set of the attribute values comprises a sequence in time of a group of sets of the attribute values. In addition, the navigation template can represent a marked state of attributes and the step of sending the at least one set of attribute values can comprise sending one set of attribute values defined by the marked state. Besides, the step of selecting a navigation template preferably comprises selecting the navigation template as a function of a type of the inspecting object.

The system for automatically generating attribute values preferably comprises a state save module connected to the storage unit for storing, as a navigation template, the attribute signals corresponding to a current state.

In the imaging system, the housing has preferably a common faceplate for both the camera and the light projectors. The housing has preferably a hexagonal shape and preferably comprises cooling fins and at least one thermoelectric cooling device to dissipate heat generated by the light projectors. In addition, the housing preferably comprises apertures of standard dimensions that can receive standard 58 millimeter lens filters and inside of which the light projectors are located, such that light projected by the light projectors is filtered by effect of the standard lens filters. Besides, the imaging system preferably comprises a mast to support components of the imaging system and motors to mechanically control orientation of the imaging system with respect to the mast.

In the method of inspecting an inspection object using optical filters, the imaging environment can be a wall of an underground conduit and, in this case, the selection of appropriate optical filters is carried out as a function of at least one of humidity inside the underground conduit and material of the wall such that the acquired image shows defects of the wall. The imaging environment can also be an underground conduit filled with liquid and, in this case, the selection of appropriate optical filters is carried out as a function of at least one of humidity inside the underground conduit and reflection properties of the liquid such that the acquired image shows the underground conduit without light projected by the liquid.

### BRIEF DESCRIPTION OF DRAWINGS

These and other features of the present invention will become more apparent from the following description in which reference is made to the appended drawings wherein:

FIG. 1 is a block diagram of an imaging system according to a preferred embodiment of the invention;

FIG. 2 is a block diagram of an imaging system according to another preferred embodiment of the invention;

FIG. 3 is a flow chart of a method of marking a state of controllable attributes of components of an imaging system according to a preferred embodiment of the invention;

FIG. 4 is a block diagram of a system for marking a state of controllable attributes of components of an imaging system and using the marking state to edit and use a navigation template according to a preferred embodiment of the invention;

FIG. 5 is a flow chart of a method of inspection of an underground conduit using a navigation template according to a preferred embodiment of the invention;

FIG. 6 is a flow chart of a method of creating an identification header using a database to automatically extract information in connection with an inspected underground conduit according to a preferred embodiment of the invention;

FIG. 7 is a block diagram of a system for creating an identification header using a database to automatically extract information in connection with an inspected underground conduit according to a preferred embodiment of the invention;

FIG. 8 is a flow chart of a method of inspecting an inspection object using optical filters.

### DESCRIPTION OF PREFERRED EMBODIMENTS

The imaging system used in the present invention is not a regular imaging system that can be hold over a shoulder but is a special imaging system mounted on a mast supported by a support member that is usually fixed to an inspection truck. For illustrative purposes, the inspection of underground conduits will be described, although the scope of the present invention in by no means limited to this application. In fact, the invention relates to the remote inspection of structures that may be examined remotely using an imaging system, such as underground conduits and railroad bridge support structures.

In the text, when it is referred to “imaging system”, it should be understood that it is referred to the part of the inspection system that is placed inside the inspecting underground conduit for imaging. The “imaging system” does not include components that do not constitute a part of the system placed inside the conduit for inspection. However, when it is referred to “inspection system”, it should be understood that it is referred to the whole system used for inspection. This comprises the imaging system as well as other components used directly or indirectly in connection with the “imaging system”.

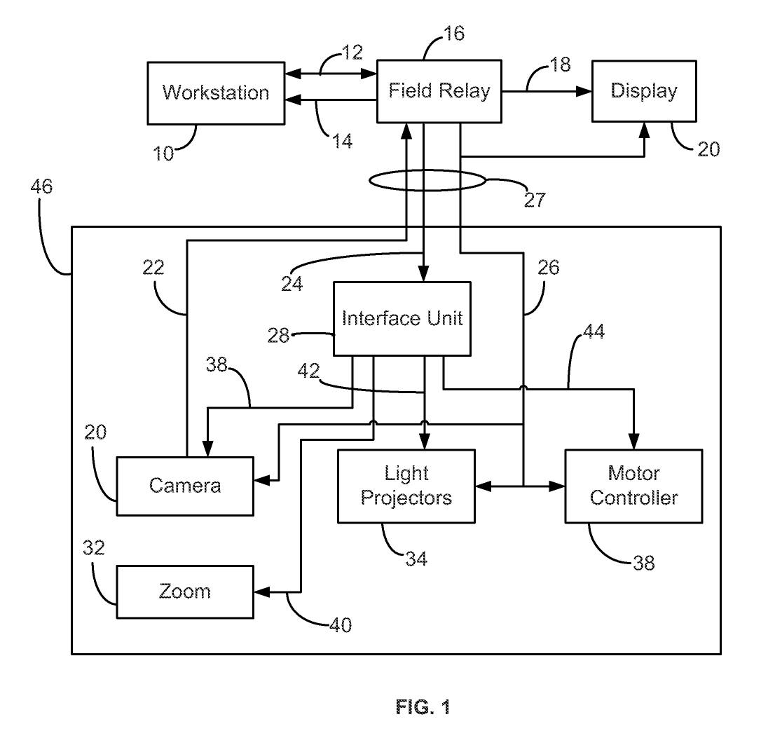

Referring first to FIG. 1, there is shown an imaging system 46 for inspection of an underground conduit connected to a workstation 10 by the intermediary of a field relay 16 with a harness 27 located in the field in proximity of the workstation 10 and far from the imaging system 46. The imaging system 46 comprises a camera 30 with controllable attributes, a high magnification ratio zoom with a zoom controller 32, a motor with a motor controller 36 and light projectors 34. The camera 30 can be either a digital or an analog one, but the zoom is necessarily an optical one to be able to provide the required quality of image. It is always possible to have simultaneously a digital and an optical zoom. The light projectors 34 are preferably electronically controllable light projectors to be able to vary their intensity.

Preferably, the imaging system 46 comprises a user interface unit 28 located in proximity of the camera 30, the zoom, the light projectors 34 and the motors. The harness 27 comprises a video cable 22 connected to the camera 30, an attribute cable 24 connected to the user interface unit 28 and a power cable 26 connected to each of the camera 30, the light projectors 34 and the motor controller 36 of the imaging system 46.

Preferably, the imaging system 46 is controlled manually from the workstation 10 from which an operator sends a control signal via a USB connection 12 to control the camera 30, the camera zoom, the light projectors 34 and the motors. Following, the field relay 16 receives the control signal sent by the workstation 10 and, in consequence, transmits various attribute signals over a single attribute cable 24 to control the different components of the imaging system 46. The attribute signals include attribute values of the camera 30, attribute values of the zoom, attribute values of the light projectors 34 and attribute values of the motors.

The imaging system 46 is electrically supplied by the means of a power supply preferably located in the field relay 16. Accordingly, the field relay 16 comprises a 110 volts socket connected to each of the camera 30, the light projectors 34 and the motor controller 36 by a power cable 26. The same power cable 26 is also connected to supply the display 20 located in proximity of the field relay 16.

The field relay 16 comprises a video input for receiving, via video cable 22, a video signal recorded by the camera 30. It is possible for the field relay 16 to be connected to the workstation 10 by a second video cable 14 to convey the received video signal for storage in the workstation 10. When the received video signal is an analog signal, a CODEC device located in the workstation 10 receives the analog video signal, converts it into a digital video signal and then compresses the digital video signal for storage.

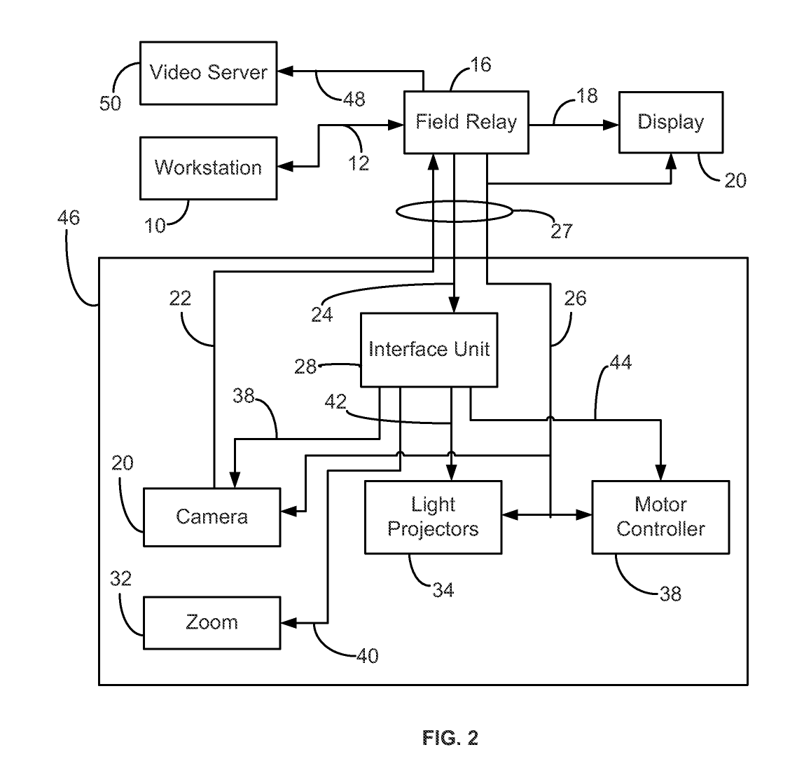

Even if it is possible to store the video signal in the workstation 10, it is preferable to have an independent server for this purpose. Accordingly, FIG. 2 shows a video server 50 connected to the field relay 16 by a fourth video cable 48. When the received video signal is analog, the video server 50 comprises a CODEC device to receive, convert and compress the received signal.

The importance to have a video server 50 independent of the workstation 10 is ordered by the fact that the vast majority of the existing trucks used for video inspections are either equipped with workstations having analogical mode equipments, such as a VHS video tape recorder, or with workstations having inappropriate characteristics for video image storage. The digitalization of video signals in real time requires a computer with a very specific architecture and data-processing components especially dedicated for this purpose.

It is preferable, in order to ensure fluidity of the image during viewings and recordings, that the server comprises several components with special characteristics, such as a video card with a video entry of a very good quality and a hard disk system of type Raid with a minimum speed of 7200 spins/s to store the video data. Furthermore, it is preferable to have a minimum of 512 MB of read-write memory and a motherboard equipped with at least a Pentium IV processor. A server with such characteristics is required to provide a good quality of image. It is also possible, after installation of especially dedicated software, to be connected to the server via a local or a remote connection (ex. USB, WIFI and Internet) in order to control recording and transferring of the video signal.

According to a preferred embodiment of the invention, the field relay 16 comprises a TV output from which the received video signal is conveyed to a display 20 via a third video cable 18. The display 20 can be an analog or a digital one according to if the received video signal is analog or digital. The display 20 is located in the field and displays the video signal recorded by the camera 30. The first utility of displaying the video signal is that it allows the operator to visualize, in real time, the video signal recorded by the camera 30, giving him the possibility to further control in consequence the attributes of the components of the imaging system 46 (i.e. zoom, light intensity, orientation of the camera, brightness of the image, etc.). Another utility of displaying the video signal is to allow an assistant operator in the field to position the imaging system appropriately in the middle of the inspecting underground conduit, the operator assistant being guided by the video image displayed. Without this innovation, it is practically impossible to carry out this operation efficiently due to the deepness of underground conduits. Another utility is that he operator can also control which part of the recorded video signal to store.

The user interface unit 28 of the imaging system 46 is responsible of all the intelligence of the imaging system 46. Even if it can also be located in the field relay 16, the user interface unit 28 is preferably located in the imaging system 46. The user interface unit 28 is provided with a microcontroller preferably containing special software using the standard protocol of communication MODBUS that allows receiving and converting signals (i.e. VISCA or other types of signals) via a single input interface and corresponding each of these received signal to its appropriate output interface, among a group of output interfaces. In the event, the user interface unit 28 receives the attribute signals over the attribute cable 24 and conveys the received attribute signals to their respective output interfaces so that they can be forwarded toward their respective destinations (i.e. camera 30, zoom, light projectors 34 and motors) by the means of various cables. Accordingly, the user interface unit 28 transmits the camera attribute values to the camera 30 via a first attribute cable 38, the zoom attribute values to the zoom controller 32 via a second attribute cable 40, the light attribute values to the light projectors 34 via a third attribute cable 42 and the motor attribute values to the motor controller 36 via a fourth attribute cable 44.

In this approach, one of the advantages to locate the user interface unit 28 in the imaging system 46 (and not in the field relay 16) is to decrease the size of the harness 27 between the field relay 16 and the imaging system 46, making it more flexible and easy to work.

The light projectors 34 are preferably electronically controllable light projectors comprising a group of projectors surrounding the camera 30. The projectors can be either bulbs or LEDs. Given the big number of projectors and in order to further decrease the size of the harness 27, it is preferable to supply the light projectors 34 from a power supply source with a converter located in their proximity. With this intention, instead of supplying the light projectors 34 from the field relay 16 with 12 volts current, it is possible to supply it with 48 volts current (that requires a thinner cable) and to convert it to 12 volts current with a 48 to 12 volts converter located in the imaging system 46.

In the course of inspection, many reasons justify the need to memorize, at a given instant, the state of attributes of the components of the imaging system. Considering the loss of time and the lack of accuracy in adjusting manually the attributes, the system allows memorizing a state of attributes at any instant during inspection, doesn't matter if the system is in an automatic or a manual mode, changing the state of attributes and then setting up the system automatically according to the memorized state of attributes. To do so, the motors are equipped with special sensors capable of detecting orientation and position of the imaging system in space. Thereafter, the system memorizes the detected orientation and position of the imaging system. From their side, the attributes of the light projectors, of the zoom and of the camera are continuously monitored, such that when the mark state command is triggered, the system reads and memorizes the last state of attributes of the components of the imaging system.

For instance, one among the utilities of marking a state is when the imaging system is in an automatic mode and the operator wants to temporally interrupt the automatic mode (for instance, to inspect manually a given zone in the field of view of the camera) and then goes back to it without losing the state of attributes of the components right before the interruption. By marking the state of the attributes before interrupting the automatic mode of the imaging system, the operator will be able to put the system in a manual mode, change the state of the attributes according to the needs (ex. change the zoom, the intensity of the projectors, the orientation of the camera, etc.) and then set up the system with the same state of attributes as right before the interruption.

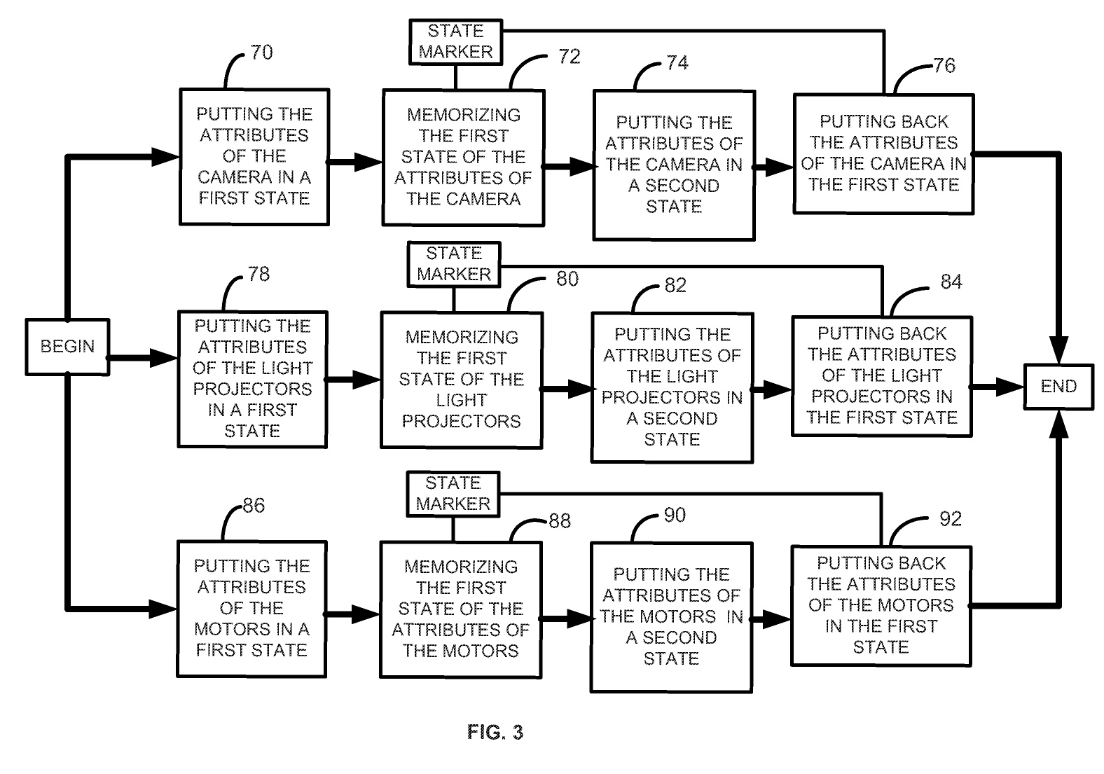

Referring to FIG. 3, there is shown a method of marking a state of controllable attributes of components of an imaging system. Initially, at least a part of the attributes of the system are put in a first state (70, 78 and 86). Following, at least a part of the attributes put in the first state are selected and have their state memorized and stored in a state marker 94 (72, 80 and 88). The attributes values of the components are then changed and put in a second state (74, 82 and 90). Finally, the system selects the marked state and instates the memorized state of the selected attributes (76, 84 and 92).

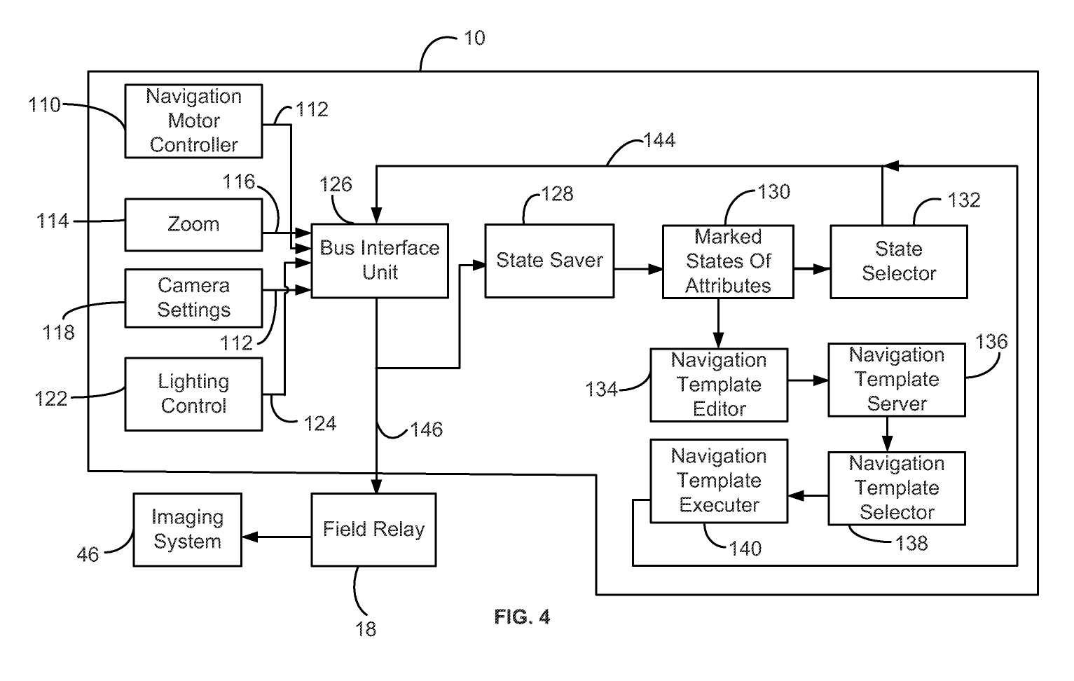

Referring to FIG. 4, there is shown a system for marking a state of controllable attributes of components of an imaging system. The system for marking a state of attributes is generally located in the workstation 10 and comprises a navigation motor controller 110, a zoom module 114, a camera setting module 118, a lighting controller 122, a bus interface unit 126, a state saver 128, a state marker 130, and a state selector/executer 132. The workstation 10 (that generally comprises the system for marking a state of attributes) is connected to the imaging system 46 via the field relay 16.

The navigation motor controller 110 is a module that receives a motor control signal for controlling the motor and sends a motor attribute signal 112 containing motor attribute values to the bus interface unit 126. The motor control signal is generated by an appropriate user-friendly interface, such as a joystick, manipulated by the operator. The zoom module 114 is a module that receives a zoom control signal generated by the operator for controlling the zoom of the camera and sends a zoom attribute signal 116 containing zoom attribute values to the bus interface unit 126. Similarly, the camera setting module 118 receives a camera control signal generated by the operator for controlling the camera and sends a camera attribute signal 120 containing camera attribute values to the bus interface unit 126. Finally, the lighting controller 122 is a module that receives a light control signal generated by the operator for controlling the light projectors and sends a light attribute signal 124 containing light projectors attribute values to the bus interface unit 126. All of the navigation motor controller 110, the zoom module 114, the camera setting module 118 and the lighting controller 122 are preferably software modules.

The bus interface unit 126 conveys the received attribute signals (112, 116, 120 and 124) to the imaging system 46 via the field relay 16 in order to control the different components of the imaging system. The operator at the workstation 10 supervises, by the means of the display 20, the change of state of the attributes of the different components. If the operator decides to mark the state of the attributes, the bus interface unit 126 conveys the attribute signals to the state saver 128 to save the attribute values. Thereafter, the state saver 128 sends these attribute values for storage in the state marker 130. In the course of inspection, when the operator selects the marked state for execution, the state selector/executer 132 sends an attribute signal 144 with the memorized state of attributes to the bus interface unit 126 to be thereafter conveyed to the imaging system 46 to control the different components.

The number of types of materials used to construct underground sewers exceeds 25 different types (ex. sandstone, steel, PVC) and they are listed and used in all the countries of the world. In general, all sewage networks are built according to a same general principle according to which conduits of small diameters are located upstream of the basin of drainage and conduits of bigger diameters are located downstream, towards the more significant collectors. The diameters thus vary from 4 inches to more than 12 feet. A typical sewage network consists of a score of different diameters. Each material has a characteristic color (ex. white, black, blue, red, etc).

Since its beginnings in the middle of the Fifties, the industry of sewers inspection encounters a persistent difficulty to generate a film accurately reproducing the real conditions observed in the conduits. Several factors combine to make the spot difficult. One among other factors is that the type of the inspected conduit (i.e. mainly, the diameter of the conduit and its type of material) influences on the reflection of the projected light and therefore impacts the quality of the recorded image. Consequently, in order to ensure a quality of image of the inspecting conduit, the attributes of the imaging system (ex. the iris, the gain, the contrast, the shutter speed, the back light compensation, etc.) should be adjusted as a function of the type of the inspecting conduit.

There is a big range of conduit types used in industry (i.e. approximately 500:25 different material types.times.20 different diameter dimensions). Adjusting manually attributes of the camera as a function of each conduit type encountered during inspection is therefore a huge time consuming and is practically impossible.

The norms of inspection being clearly defined by the municipal authorities, the actions constituting a standard inspection are clearly detailed and known. In this view, a standard inspection of an underground conduit is generally constituted of a series of repetitive actions, where each action is generally constituted of three phases: 1) positioning the camera in the center of the conduit and carrying out a rotating movement from 7 to 6 hours in order to inspect the crown of the pipe, 2) making a zoom-in and 3) making a zoom-out). The rotation angle of the camera and the intensity of the light projectors must be selected appropriately according to a type of the inspecting conduit (i.e. diameter dimensions and type of material).

The conduit inspection standardization makes it possible to automate conduit inspection systems. In this order, the system uses navigation templates especially adapted for various types of inspecting conduits. Each navigation template contains, for a given type of an inspecting conduit, at least one set of predefined attribute values of the components of the imaging system (i.e. attributes of the camera, attributes of the projectors, attributes of the motors, attributes of the zoom, etc). Navigation templates can have one set of attribute values but, generally, they contain a sequence in time of a group of sets of attribute values allowing the inspection system to operate in an automated mode for a given period of time. Also, navigation templates can, partially or totally, be made of one or a group of marked states.

Generally, a navigation template operates as follows: once the imaging system positioned in the center of the pipe, the operator selects the inspecting conduit type (i.e. the diameter and the type of material) and the system automatically selects and executes a suitable navigation template as a function of the selected inspecting conduit. Thereafter, all the attributes of the components of the imaging system are adjusted automatically. If the given navigation template contains a sequence in time of a group of attribute values, the imaging system will then navigate in an automated mode for a given period of time. The operator visualizes the course of the operation by the means of the display 20 or the workstation 10.

It is possible to conceive a navigation template that, when executed, activates attributes of only a part of components of an imaging system. This makes it possible to automate only a part of the components of the imaging system (for instance, automating the zoom) and to preserve a manual mode for the other part of the components (for instance, preserving a manual operability to vary the intensity of the projectors and the orientation of the camera). A navigation template can also be interrupted in court of execution while preserving a marker (state marker) memorizing the attribute values of the components of the imaging system right before the interruption. The system also allows the creation of new navigation templates for new types of conduits not envisaged originally by the system.

Thanks to navigation templates, the inspection of conduits becomes much less time consuming because the need for repetitive manual adjustments is minimized. The productivity is therefore increased.

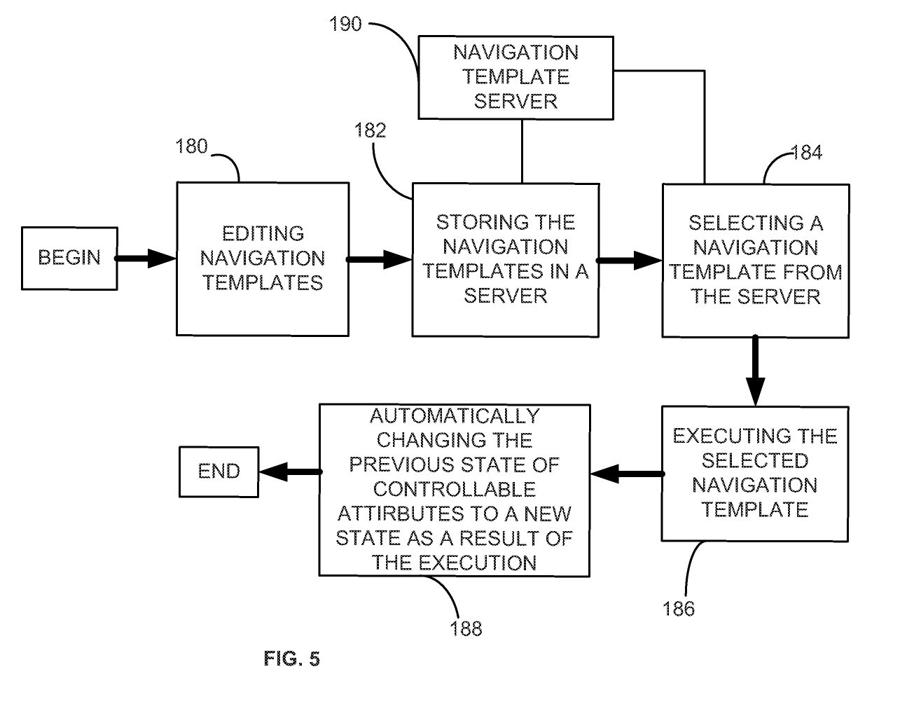

Referring to FIG. 5, there is shown a method of inspection of an underground conduit using a navigation template. Generally, navigation templates are edited 180 and stored 182 in a navigation template server 190 before starting the inspection. Even if navigation templates are usually edited as a function of types of inspecting conduits and stored prior to the inspection, it is always possible to edit navigation templates in the course of inspection, for instance, by marking and memorizing a given state of attributes. Following the edition 180 and the storage 182 steps, the operator selects a given navigation template (among a group of navigation templates) 184 from the navigation template server (that can be the same physical device as the workstation) 190 to be eventually executed 186. Generally, the selection of the navigation template is carried out as a function of the type of the inspecting conduit. Upon execution of the selected navigation template, the attribute values contained in the selected navigation template are sent to the imaging system to automatically navigate the imaging system according the selected navigation template 188. In other words, the system changes the previous state of attributes of the components of the imaging system to a new one according to content of the executed navigation template 188.

Referring to FIG. 4, there is shown a system for inspecting an underground conduit using a navigation template. The system comprises a navigation template editor 134, a navigation template server 136, a navigation template selector 138 and a navigation template executer 140. Normally, all these components are located within the workstation 10. The navigation template editor 134 allows editing new navigation templates and is connected to the navigation template server 136 to store the edited navigation templates. According to one aspect of the invention, the navigation template editor 134 is also connected to the state maker 130 to receive a marked state when required. In fact, the edited navigation templates are usually edited manually and stored prior to the inspection, but it is also possible to edit navigation templates from the marked states of attributes. The navigation template selector 138 allows selecting a given navigation template according to a choice of the operator and it is connected to the navigation template server 136 to select and receive the given navigation template among a group of stored navigation templates. The navigation template executer 140 is responsible for executing the selected navigation template and sending this selected navigation template to the imaging system 46. Therefore, the navigation template executer 140 is connected to the navigation template selector 138 to receive and execute the selected navigation template. The navigation template executer 140 is also connected to the bus interface unit 126 to send to the imaging system an attribute signal 144 containing the selected navigation template for automatically navigating the imaging system 46 according to the selected navigation template.

After inspection, the video generated in connection with a given inspected conduit should be clearly identified. To be able to associate correctly an inspection video file with its corresponding inspected underground conduit, the video file is labeled as a function of the names of the conduit and of the inspection project. Also, the system allows inserting, at the beginning of the introduction video, an introduction video containing identification information about the inspected: conduit to clearly identify the latter. Identification information comprises the number, the geographic localization and the type (i.e. material type and dimensions) of the conduit.

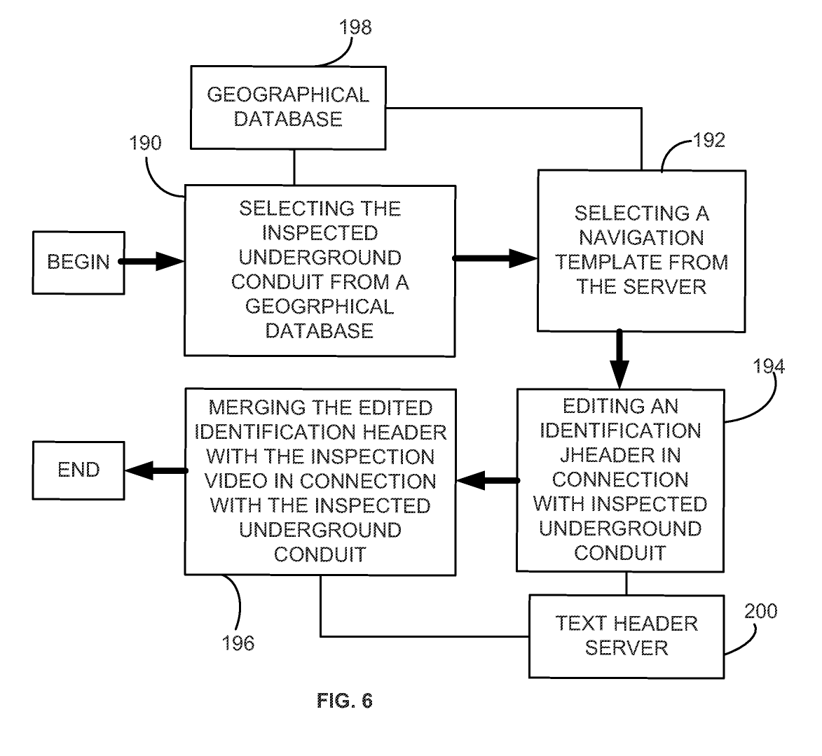

Entering the identification information manually is subject to human errors, where the need to enter the information automatically, without human intervention. Referring to FIG. 6, there is shown a method of creating an identification header using a database to automatically extract information in connection with an inspected underground conduit. The operator starts by selecting, from a database 198 (i.e. geographical or relational database), the inspected underground conduit 190. Thereafter, the system extracts, from the database 198, information in connection with the inspected underground conduit 192. Such information comprises the number, the localization and the type of the inspected underground conduit. Following, the system automatically edits a text identification header in connection with the inspected underground conduit 194 and stores the text header in a text header server 200. Finally, the system merges the edited identification header with the inspection video in connection with the inspected underground conduit 196. This method being free of any human intervention, editing errors (that usually occur when information is entered manually) are eliminated. Moreover, this automated method is faster and more reliable than any other manual method used for creating identification headers in connection with conduits. When the edited information header contains too much information to fit within a sole page, the system spreads automatically the identification information over as many consecutive pages as necessary.

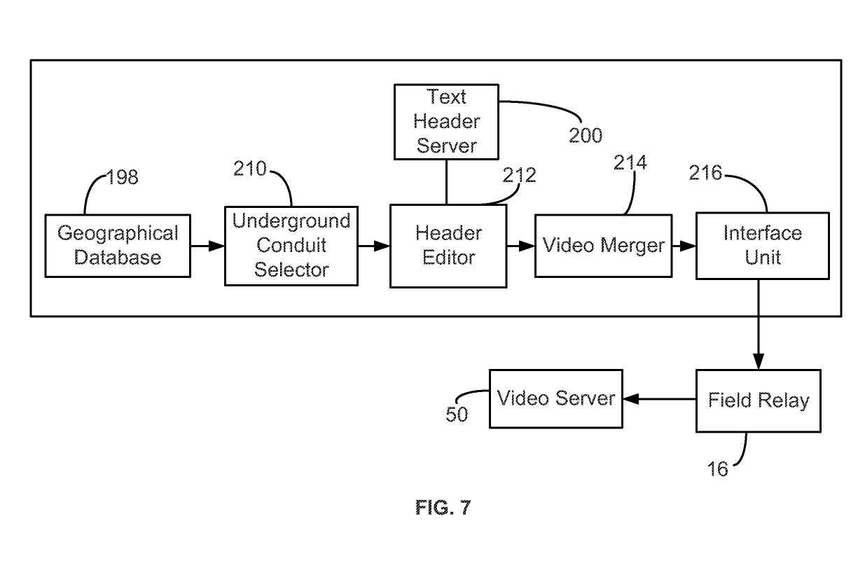

Referring to FIG. 7, there is shown a system for creating an identification header using a database to automatically extract information in connection with an inspected underground conduit. The system comprises a database 198 (i.e. geographical or relational database), an underground conduit selector 210, a header editor 212, a text header server 200, a video merger 214 and a system interface unit 216. The underground conduit selector 210 is connected to the database 198 to select the inspected conduit among a group of conduits and to extract information in connection with the selected underground conduit. The Header editor 212 is connected to the underground conduit selector 210 to receive information about the selected underground conduit. Thereafter, the header editor proceeds to edit an identification header according to the received information and stores the edited identification header in the text header server 200. When activating the header edition process, the operator can choose editing options, such as characters' style, size and color. The video merger 214 is connected to the header editor 212 to receive the edited header. The video merger 214 merges the received identification header with the inspection video in connection with the inspected conduit and sends the resulting video to the system interface unit 216 that conveys it to the video server 50 via the field relay 16. When the database 198 is updated with new information about the inspected underground conduit, the header editor 212 provides the possibility to automatically update the associated identification header as well as the associated inspection video to take into account the new information. An update operation in connection with a given identification header can be repeated as many times as necessary without any risk of deteriorating the quality of the inspection video.

The light projectors of the imaging system are preferably electronically controllable light projectors, such that the operator can control their intensities remotely. The system provides a camera with a high magnification zoom surrounded by at least 5 projectors to provide necessary lighting in the inspecting conduit. The reason to place the light projectors all over the circumference surrounding the camera is to be able to provide uniform lighting for all the circumference of the conduit without creating shadow zones in the bottom side of the camera. The light projectors should have an appropriate size such that the circumference on which they stand does not exceed 8 inches to be able to insert the imaging system in narrow places. The camera and the light projectors are preferably contained inside a hexagonal housing with a common faceplate for both the camera and the light projectors. The housing preferably comprises cooling fins and at least one thermoelectric cooling device (ex. Peltier device) to dissipate heat generated by the light projectors. The camera and the light projectors are arranged in such a way that the camera is centered inside the housing and the light projectors surround the camera.

Moreover, the housing comprises apertures of standard dimensions that can receive standard 58 millimeter lens filters and inside of which the light projectors are located, such that light projected by the light projectors is filtered by effect of the standard lens filters in order to improve quality of imaging. The filters are generally chosen as a function of the imaging environment. When the latter is a wall of an underground conduit, the optical filters are generally chosen as a function of material of the wall and the humidity rate inside the underground conduit, such that the acquired image shows clearly defects on the wall. When the inspecting conduit is filled with liquid, selection of the optical filters is carried out in considering reflection characteristics of the liquid, such that the acquired image is free of light projected by the liquid.

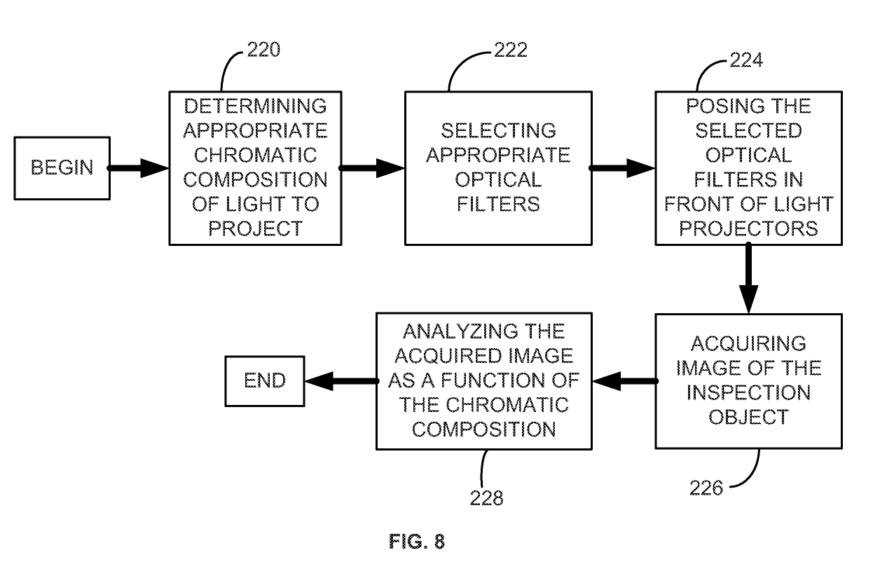

Referring to FIG. 8, there is shown a method of inspecting a conduit using optical filters. First, the operator determines an appropriate chromatic composition of light to project as a function of imaging environment 220. Second, the operator selects appropriate optical filters as a function of the appropriate chromatic composition of light to project 222. Third, the operator poses the selected optical filters in front of light projectors of the inspection system, such that light projected by the light projectors on the inspection object is filtered by effect of the posed optical filters 224. Fifth, the system acquires the image of the inspection object 226. Finally, the acquired image is being analyzed as a function of the chromatic composition of the projected light 228.

1. A method of automatically generating attribute values defining controllable attribute values of an inspection imaging system for inspecting an object, the method comprising:
manually setting each of the to put the inspection imaging system in an initial state;
selecting a navigation template among stored navigation templates, where the navigation template contains at least one set of the attribute values defining controllable attribute values of the inspection imaging system;
executing the navigation template during inspection of the object to generate the at least one set of the attribute values, the attribute values including camera orientation, camera zoom and lighting intensity; and
sending the at least one set of the attribute values to the inspection imaging system to automatically navigate according to the selected navigation template.

2. The method as claimed in claim 1, wherein the at least one set of the attribute values comprises a sequence in time of a group of sets of the attribute values.

3. The method as claimed in claim 1, wherein: the navigation template represents a marked state of attributes, and sending the at least one set of the attribute values comprises sending one set of attribute values defined by the marked state.

4. The method as claimed in claim 1, wherein the step of selecting a navigation template comprises selecting the navigation template as a function of a type of the object.

5. A system for automatically generating attribute values defining controllable attribute values of an inspection imaging system, the system comprising:
a user interface unit for receiving commands from an end user to define the controllable attribute values;
a motor control module connected to the user interface unit for acquiring a first user friendly data command and for outputting a first attribute signal to control position and orientation of the inspection imaging system;
a zoom module connected to the user interface unit for acquiring a second user friendly data command and for outputting a second attribute signal to control a high magnification ratio zoom of a camera of the inspection imaging system;
a camera module connected to the user interface unit for acquiring a third user friendly data command and for outputting a third attribute signal for controlling attributes of the camera;
a light projector module connected to the user interface unit for acquiring a fourth user friendly data command and for outputting a fourth attribute signal for controlling attributes of electronically controllable light projectors of the inspection imaging system;
a system interface unit for receiving the first, second, third and fourth attribute signals and for outputting corresponding imaging system control signals; a storage unit for storing navigation templates, where each of the navigation templates contains at least one set of the attribute values defining the controllable attribute values of the inspection imaging system;
a select module connected to the storage unit for selecting a navigation template among the navigation templates in the storage unit; and
an execute module connected to the select module for executing the selected navigation template and for outputting the selected navigation template to the inspection imaging system via the system interface unit.

6. The system as claimed in claim 5, further comprising: a state save module connected to the storage unit for storing, as a navigation template, the first, second, third and fourth attribute signals corresponding to a current state.

7. A method of creating a text identification header using a database to automatically extract information in connection with an object, the method comprising:
navigating an inspection imaging system mounted on a mast supported by a support member for inspection the object;
recording the inspection to create an inspection video in connection with the object;
selecting the object in a database containing information about the object;
extracting, from the database, the information about the object;
using the extracted information for automatically editing the text identification header in connection with the object; and
merging the text identification header with the inspection video in connection with the object.

8. A system for creating an identification header using a database to automatically extract information in connection with an object, the system comprising:
an inspection imaging system mounted on a mast supported by a support member to inspect the object;
a storage unit for containing information about a given group of objects;
a select module connected to the storage unit for selecting the object among the given group of objects in the storage unit;
a header edit module connected to the select module for editing the identification header in connection with the object; and
a video merge module connected to the header edit module for merging the edited identification header with an inspection video in connection with the object.
